(19) United States
(12) Patent Application Publication
(10) Pub. No.: US 2011/0089797 A1
(43) Pub. Date: Apr. 21, 2011

(54) MULTI-MATERIAL CABINET

(75) Inventors: Adrian Ronald Simms, Powell, OH (US); Albert Stephen King, Renton, WA (US); Matthew Allen McCarthy, Worthington, OH (US); Gary Hamberg, Van Wert, OH (US)

(73) Assignee: CVG Management Corporation, New Albany, OH (US)

(21) Appl. No.: 12/905,516

(22) Filed: Oct. 15, 2010

Related U.S. Application Data
(60) Provisional application No. 61/252,501, filed on Oct. 16, 2009.

(51) Int. Cl. A47B 96/00; B29C 45/00

(52) U.S. Cl. 312/326; 312/352; 29/527.1

(57) ABSTRACT

A strength-enhanced lightweight cabinet system that employs a combination of lightweight composite materials is disclosed. The materials employ a combination of different processes to create a lightweight cabinet system that is structurally sound and functional. In aspects, the combination utilizes two reaction injection molding processes, and one conventional injection molding process. One of the reaction injection molding processes is IVCR (Improved Vinyl Clad Rigid) while the other is T-RIM™. The combination of these materials and processes results in a cabinet system that reduces the weight considerably over a conventional steel and/or combination of steel and other materials that is used in heavy truck sleeper cabs today.

### CROSS-REFERENCE TO RELATED APPLICATIONS

This application claims the benefit of U.S. Provisional Patent application Ser. No. 61/252,501 entitled “MULTI-MATERIAL CABINET HAVING A HIGH STRUCTURAL STRENGTH TO WEIGHT RATIO AND MANNER OF FORMING SAME” filed Oct. 16, 2009. The entirety of the above-noted application is incorporated by reference herein.

### TECHNICAL FIELD

The innovation relates generally to the field of cabinet and storage compartment construction and, more particularly, to a type and method of cabinet construction utilizing a multi-material array of components that achieve a high structural strength to weight ratio.

### BACKGROUND

Most typical cabinet or storage compartment construction relies on a rigid and strong shell, generally composed of a top, bottom, sides, and back, referred to as the “carcass,” to provide structural integrity for the cabinet. Doors and shelves may or may not be present in such a cabinet, and if present, typically contributes little, if at all, to the overall strength of the cabinet.

In order to achieve sufficient structural strength in the cabinet, the carcass is often quite heavy and rigid. While for many applications this may be an asset, or at least not a liability, in others, achieving strength with weight is a definite detriment.

Particularly in vehicle applications, weight is a paramount issue, and achieving high structural strength to weight ratios is critical to overall fuel efficiency. In particular, long-haul tractor trailers generally incorporate at least basic living quarters for a driver or drivers, and therefore most often include a variety of cabinetry applications in such living quarters. There is a need in the art to provide cabinetry applications that optimally combine strength with light weight, and employ the use of durable, attractive, and easy to clean materials.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a lightweight cabinet system that employs a combination of lightweight, yet ridged, composite materials. In aspects, the materials employ a combination of two or three different processes to create a lightweight cabinet system that is structurally sound and functional. As desired, the cabinet can be color matched to suite an application or customer's requirement. The surface can also be textured to meet an end user's styling requirements.

In aspects, the combination utilizes two reaction injection molding (RIM) processes, and, if desired, one conventional injection molding process. One of the reaction injection molding process is IVCR (Improved Vinyl Clad Rigid) while the other is T-RIM™. IVCR is a vinyl clad rigid material whereas the vinyl is inlaid in the mold prior to injecting the plastic material. The plastic material is created by combining two chemicals a ratio to create a lightweight plastic material that is used in this vinyl clad process. T-RIM™ is a reaction injection molded material that is produced in a similar process described above with the addition of a filler material that adds structure and rigidity.

The combination of these materials and processes have resulted in a cabinet system that reduces the weight considerably over a conventional steel and/or combination of steel and other materials that is used in heavy truck sleeper cabs today.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example assembled elevated perspective view of an embodiment of the innovation;

FIG. 2 illustrates an example exploded elevated perspective view of an embodiment of the innovation;

FIG. 3 illustrates an example flow chart of procedures that facilitate manufacture of a multi-composite cabinet system in accordance with an aspect of the innovation.

FIG. 4 illustrates an alternate example exploded view of a cabinet system in accordance with aspects of the innovation.

FIG. 5 illustrates an example exploded view of a cabinet system having an integral side to bottom surface in accordance with aspects.

FIG. 6 illustrates an exploded view of a backless cabinet system having integral side surfaces in accordance with aspects.

FIG. 7 illustrates an exploded view of an example cabinet system having integral side to bottom surface sections in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

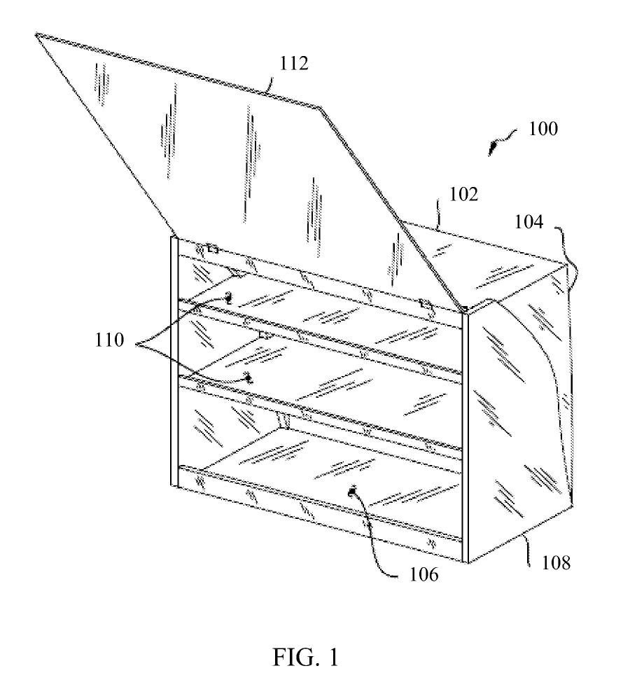

Referring initially to the drawings, FIG. 1 illustrates an example assembled elevated perspective view 100 of an embodiment of the innovation. In accordance with the innovation, traditional injection-molded plastic and metal assemblies are replaced with a composite design that can achieve significant part consolidation and weight savings. As will be appreciated upon a review of this specification, the innovation can provide for a high strength to weight ratio. When used in vehicle applications (e.g., long-haul trucks, motorhomes, aircraft, etc.), fuel efficiency can be enhanced due to the reduced overall weight.

As shown in FIG. 1, the example cabinet 100 can include a top surface 102, a back surface 104, a bottom surface 106, two side surfaces 108, multiple shelves 110 and a door surface, 112. As described herein, the components (102, 104, 106, 108, 110, 112) can configure an overhead storage cabinet in trailer-truck sleeper compartments. While overhead storage cabinets are described, it is to be understood that floor mounted or stand-alone cabinets are to be included within the scope of this disclosure without departing from the spirit and/or scope of the features, functions and benefits described herein.

it will be understood that the innovation (e.g., cabinet 100), combines multi-material construction that enhances the strength to weight ratio. In other words, by strategically employing different materials in construction, the innovation provides for a high strength, low weight cabinet assembly that can used in most any application, including, but not limited to, vehicle applications such as long-haul truck cabs, motorhomes, aircraft, etc.—all enhancing fuel efficiency. In aspects, the innovation employs material manufactured by way of IVCR (improved Vinyl Clad Rigid) and RIM (Reaction Injection Molding) techniques. These and other techniques will be described in greater detail infra.

This new lightweight cabinet system is a combination of lightweight plastic materials that utilizes a number of different (e.g., three) processes to create a lightweight cabinet system that is structurally sound and functional. It is to be appreciated that the cabinet (e.g., 100) has the ability to be color matched as desired. As well, the show surface can be textured to suite an end user's styling requirements.

In aspects, the combination utilizes two reaction injection molding (RIM) processes, and 1 conventional injection molding process to manufacture parts that form the cabinet. For example, IVCR can be used to manufacture the outer casing top and sides.

IVCR is a vinyl clad or covered material process whereby the vinyl is inlaid in the mold prior to injecting the plastic material. The plastic material is created by combining two chemicals, isocyanate and polyol in an approximate ratio of 50-50. This combination of chemicals creates a lightweight plastic material that is used in this vinyl clad process. As stated supra, this process creates a lightweight structure with a class A vinyl covering which can be color matched and also textured to suite the end user's requirements.

T-RIM™ is a reaction injection molded material that is produced in a similar process described above with the addition of a filler material that adds structure and rigidity. In one aspect, the filler that is utilized in this process is wollastonite. Additionally, in this aspect, the injection molding material is a 20% glass filled polypropylene that utilizes the gas assist process to help fill out and pack out the structural design of the product.

The combination of these materials and processes (IVCR and T-RIM™) have resulted in a cabinet system that reduces the weight considerably over a conventional steel and/or combination of steel and other materials that is used in heavy truck sleeper cabs today. As described above, this cabinet system (and manufacture thereof) can also be used in other applications of a similar requirement, e.g., motorcoach, motorhome, aircraft, etc. In addition to the multiple manufacturing processes, magnets can be embedded in molding surfaces to hold metal parts co-molded into non-metallic materials in place. This process will be better understood upon the review of the specification herein.

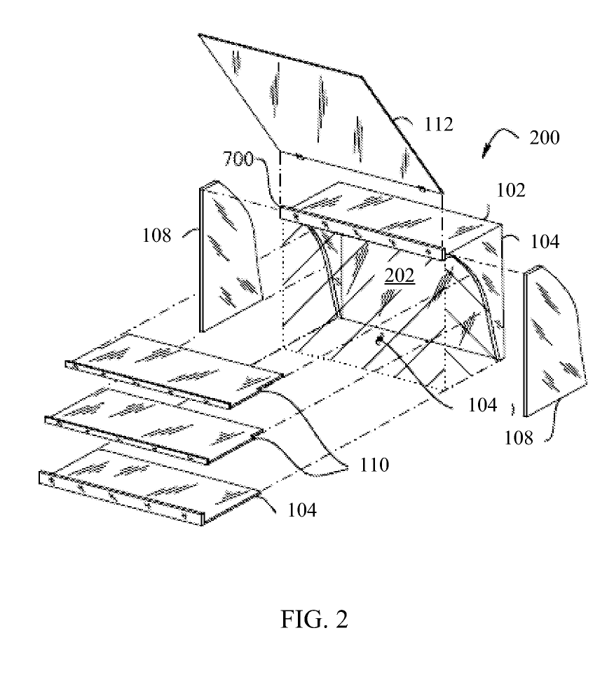

FIG. 2 illustrates an example exploded elevated perspective view of an embodiment of the innovation. As shown, the exploded view of a case 200 of FIG. 2 employs a top surface 102, a back surface 104, a bottom surface 106, two side surfaces 108, multiple shelves 110 and a door surface 112 (e.g., a hinged door).

As illustrated in FIG. 2, the top surface 102 and back surface 104 can be molded into a single base unit 202. The side surfaces 108 can be fixedly attached to the door 112 thereby forming a door closure assembly. While specific shapes, sizes or configurations are shown, it is to be understood that most any shapes, sizes or configurations can be employed without departing from the spirit and scope of this specification.

The plurality of shelves 110 can be integrated into the housing so as to provide a “spine-like” strength to the cabinet 200. These shelves 110 can be slidably inserted or otherwise fixedly positioned within the cabinet 200. It is to be understood that most any mechanism of support or attachment can be used to position the shelves 110 including, but not limited to, guides, rails, blocks, rollers, pins, adhesives or the like.

It will be appreciated that the decreased weight of the cabinet designs described herein can contribute to enhance fuel savings of a long-haul truck as well other vehicles (e.g., motorcoaches, motorhomes, buses, trains, aircraft, etc.). In the described example, for trailer-truck operators in the long-distance commercial transport market, every pound saved in vehicle weight can translate to higher payload capacity and/or better fuel efficiency. This is especially useful as price of diesel fuel increases. The fuel savings potential is but one motivating factor behind the research and development of the multi-composite cabinet design described herein.

Used in “sleeper cab” models of long-haul trucks, the multi-composite bins of the innovation provide more functional and inviting “sleepers” for long-haul truck-driving teams. The innovation discloses (and claims) a design (and process of manufacture) that replaces conventional injection-molded plastic and metal assemblies with a multi-composite design which achieves significant part consolidation and weight savings. In addition to these benefits, the innovation provides a high strength to (low) weight ratio by employing novel processes to manufacture cabinet assemblies in accordance with the specification.

It is to be understood that the innovation's design enhances strength in certain areas, for example, via tailored load paths such that other areas need not have as much strength or stiffness as compared to conventional designs. This multi-composite design can reduce parts count as well as overall material cost.

In operation, the innovation employs multiple processes to manufacture the individual components that make up the cabinet assembly 200. As described in greater detail infra, each method contributes key characteristics that can enhance or optimize a particular component's intended performance.

Upon developing the innovation, one primary goal was to design a cabinet having less weight while still maintaining adequate performance (e.g., strength), while also meeting a desired manufacturing cost target.

The design process of the example aspect employs a multi-piece (multi-composite) cabinet approximately 30 inches/762 mm high and 18 inches/457 mm deep, in two configurations. A “single” cabinet design example is approximately 20 inches/508 mm wide. Additionally, a “double” cabinet design example is approximately 45 inches/1,143 mm wide. It will be understood that these parameters are provided to add context and perspective to examples of the innovation—they are not intended to limit the scope of this innovation in any manner. Rather, the variations in size and design can offer a designer (or customer) many options for various sleeper cab configurations, while at the same time, reducing weight as compared to traditional designs. Furthermore, single and double cabinets can be the modular building blocks which could also be combined into one “long” cabinet version. This modularity enhances application of the disclosed design.

Proceeding with part or component design was an evaluation of the manufacturing approach for the various pieces or components that make up the cabinet assembly 200. In accordance with the innovation, at least three rapid and cost-effective molding processes that could efficiently meet the design benchmarks for the individual parts were selected.

In the described aspect, the cabinet's 200 primary load-bearing elements, the two inner shelves 110, are injection molded using a glass fiber-filled, impact-modified polypropylene. The cabinet enclosure, which includes two end panels 108, a one-piece back/top panel 202, a bottom shelf 104 and optional doors (112), are made using two separate reaction injection molding (RIM) methods.

The first, a method termed T-RIM™, is used for the cabinet's bottom shelf 104. The material is a two-part, thermoset urethane foam system reinforced with an “organic” filler. In one aspect, the filler material is wollastonite, a calcium inosilicate mineral (CaSiO3) that may contain small amounts of iron, magnesium, and manganese substituting for calcium.

In the example, the second RIM method can be used for the remainder of the cabinet enclosure elements. Referred to here as Improved Vinyl Clad Rigid, or IVCR. The IVCR method uses the same urethane foam resin system, but need not employ added reinforcement. Both RIM processes can incorporate cosmetic vinyl outer skins and co-molded steel inserts to accommodate fasteners during cabinet assembly. Additionally, as desired, the top good can be excluded as appropriate.

In accordance with the embodiment, the injection molding tools for the two shelf sizes, single and double, are manufactured of P20 tooling steel, while the RIM tools are made of aluminum and equipped with integral vacuum systems. It is to be understood that all three tool sets can have internal gun-drilled and cast water channels that can speed heating and cooling during the molding cycle.

By design, during cabinet production, the three processes can run concurrently. First, the T-RIM™ bottom shelf mold can be cleaned and prepped by the application of a standard mold release. Thereafter, a layer of material (e.g., 0.040-inch/1-mm thick layer of vinyl), can be prepped for insertion into the mold cavity. The material can first be warmed, then “tentered” on a rack to stretch and conform it to the general mold dimensions. The rack can be moved to the mold and the material, e.g., vinyl, can be positioned in the proper position. It is desirable to avoid distortion or any wrinkling while the tool's vacuum system is activated to “dog” the vinyl and hold it in place.

Next, steel inserts can be placed in the tool at the specified fastener locations, indicated by registration marks or indents in the tool surface. Thereafter, the mold can be closed. Magnets, built into the male tool half, can secure the inserts in place during injection. Next, the polyol and isocyanate components can be pumped by a meter/mix machine into a mixing head, e.g., a Cannon FPL mixing head from Cannon SpA (Borromeo, Italy).

The components can be mixed at high pressure, approximately 2,000 psi/137.9 bar. The tool can be heated and the appropriate amount of combined liquid polyurethane resin is dispensed by the machine from the head into the closed mold through the mold gate. Within minutes, the resin flows throughout the mold cavity. Heat provided by the tool's hot water channels facilitates cure and assists adequate bonding to the vinyl “top good.” Because the foam reaction is exothermic, the water channels also allow heat transfer away from the parts, which facilitates part cooling. When molds are opened, therefore, the cured parts can be removed by hand.

Although cure time depends on part geometry, thickness and exact resin formulation, for the parts of the example embodiment, the cure time ranges from three to five minutes. The polyurethane foam is a “skinning” foam system. In other words, when cured, the foam creates a tough skin layer over the more porous foam interior. It is to be appreciated that this characteristic gives the part some flexibility. Thus, the example cabinet(s) are easy to install and imparts a bit more ‘user-friendliness’ than conventional cabinet designs.

The IVCR molding process works in much the same way as described above, with similar mold preparation, vinyl layup and insert placement. Urethane resin is mixed in the same (or similar) mix head and injected into the closed tools, with cure taking essentially the same amount of time.

In aspects, molding of the load-bearing inner shelves (e.g., 110 of FIG. 1) is accomplished with an injection molding machine equipped with a gas-assist mechanism. It will be appreciated that “gas-assist” refers to the injection of nitrogen gas at low pressure into the resin melt stream immediately after the filled resin is injected into the mold. The gas moves along channels machined in the tool surface, forcing the hot resin (e.g., 20 percent chemically coupled glass-reinforced polypropylene) away from the channels. This not only helps to fill the mold, but also creates hollow cavities along the channels. Thus, in this example, less resin is used, making the process more cost-effective than traditional molding. Greater dimensional stability in the part also is possible because heat stresses are not as large a factor when the part has hollow cavities.

In aspects, the part can be designed with grid stiffening ribs on the underside, with several of the ribs incorporating gas runners. It will be understood that thick polypropylene parts can warp during cooling. Therefore, the gas assist can be employed to create a thinner shelf with reinforcing grids on the back side, some of which are hollow. The grid design not only reduces overall part weight, but because it is thinner, the part also cools faster, therefore, has less chance of warping. The glass loading can also help maintain dimensional stability and reduce the part's coefficient of thermal expansion. Mold cooling after injection is accomplished with water channels which “sets” the thermoplastic prior to demolding.

In accordance with the manufacture of the subject innovation, touch labor can be significantly reduced because, as a result of the molding processes described herein, the parts need not have extensive finishing. In most cases, only minor trimming of excess vinyl material from the molded part edges and removal of flash is required. Additionally, because fasteners are received by the co-molded metal inserts during assembly, drilling is not necessary, even during bin installation. In accordance with these aspects, the bins are installed by inserting fasteners through molded-in holes in the cabinet's one-piece back/top panel directly into the wall of the sleeper cab. It will be appreciated that large washers can assist to relieve cabinet load stresses.

In addition to the overall lighter weight as described supra, the cabinets can provide better acoustic and thermal properties for truckers. For example, most U.S. states have instituted a ‘no-idle’ regulation whereby a trucker is not permitted to sleep in the truck with the motor running. It will be appreciated that the softer composite cabinets can absorb noise thereby muffling outside noise and providing better insulation than the traditional metal and plastic designs. The cabinet design (and manufacturing process thereof) represents an innovative design for production that can reduce both weight and cost for truckers.

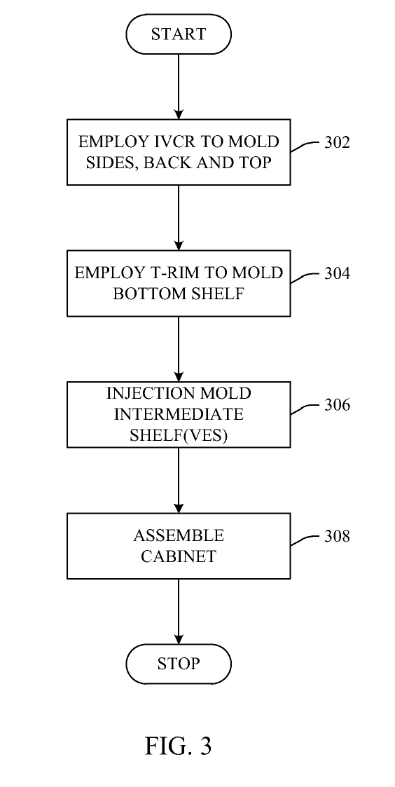

FIG. 3 illustrates a methodology of manufacturing a cabinet in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

The innovation discloses a multi-composite overhead storage bin design for trailer/truck sleeper cabs, among other applications. These multi-composite bins can replace previous metal and plastic cabinets, resulting in significant weight savings.

As described herein, the all-composite cabinets are manufactured of several components, produced via multiple (e.g., three) distinct molding processes. In accordance with the cabinet of the aforementioned example, the enclosure's side panels and back/top panels are made with Improved Vinyl Clad Rigid (IVCR) reaction injection molding (RIM). The bottom shelves are made via T-RIM™, a reinforced RIM molding process. The intermediate shelves can be injection molded.

At 302, the IVCR process is employed to mold the sides, back and top surfaces of the cabinet assembly. It will be appreciated that the IVCR molds are two piece molds. In operation, one side of the mold includes integral magnets (e.g., on the upper (male) mold surface), which hold the co-molded fastener inserts in place during processing.

In accordance with the IVCR process, before injection of the two-part urethane resin into the cabinet side panel mold, the cosmetic vinyl top good is placed in the mold and “dogged,” or held in place, by the mold's integral vacuum system. In an example, a molded side panel part is removed from the mold after cure, which can take several minutes. Only minimal finishing is needed, to trim the excess vinyl from the part edge.

In a de-molded side panel, ridges are present that, when assembled, accept the injection-molded shelf parts as shown in FIGS. 1 and 2. In the example, and in addition to molding of the side panels, a back/top panel is also is produced using IVCR. At this stage, two parts await de-molding from the two-part aluminum mold. Once molded, the back/top panel can be de-molded and trimmed as required or desired.

Referring again to FIG. 3, at 304, the bottom shelf of the example cabinet can be molded using a T-RIM™ process. As described above, T-RIM™ is a reaction injection molded material that is produced in a similar process to IVCR as described above, with the addition of a filler material that adds structure and rigidity. In one aspect, the filler that is utilized in this process is wollastonite. The intermediate shelves are injection molded at 306. Finally, at 308, the cabinet can be assembled. It is to be understood that an optional door or closure assembly can be employed. Most often, the door assembly will be manufactured by way of the T-RIM™ process. In other aspects, IVCR or general injection molding processes can be employed to manufacture the door or closure assembly.

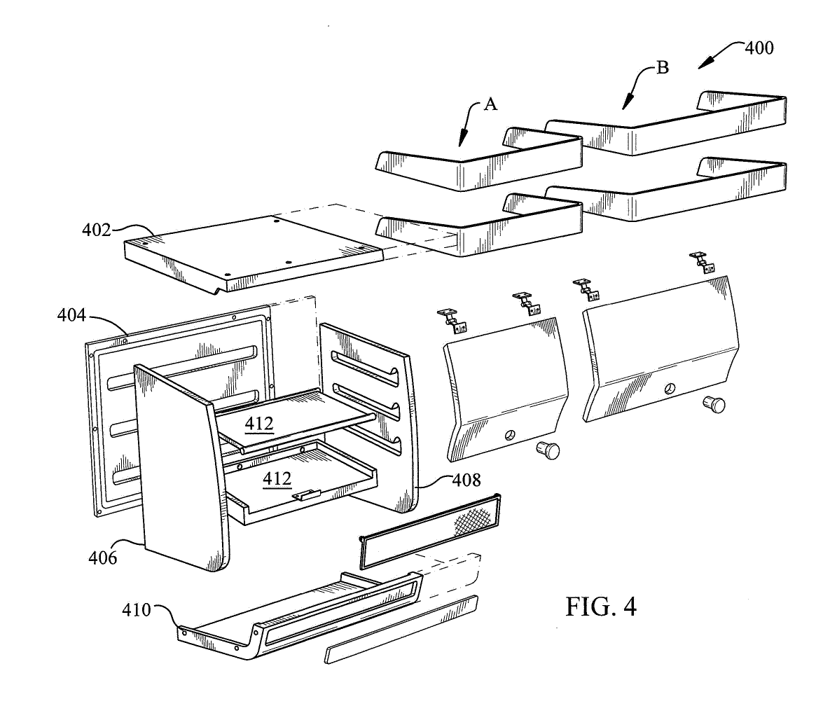

Referring now to FIG. 4, an alternative example of cabinet assembly 400 in accordance with the innovation is shown. As illustrated, many of the parts can be common (or similar) in a “single” or “double” design modular design. As described in detail supra, the subject specification discloses a multi-material cabinet having a high structural strength to weight ratio (400). The described embodiments of the apparatus 400 accomplish advancements by new and novel methods that are configured in unique and novel ways and which demonstrate previously unavailable but preferred and desirable capabilities. The description set forth herein, in connection with the examples and drawings, is intended merely as a description of the embodiments of the innovation, and is not intended to represent the only form in which the innovation may be constructed or utilized. The description sets forth the designs, functions, means, and methods of implementing the features, functions and benefits of the innovation in connection with the illustrated embodiments. It is to be understood, however, that the same or equivalent functions and features may be accomplished by different embodiments that are also intended to be encompassed within the spirit and scope of this specification.

The systems (and methods) of the innovation divert from the traditional paradigm of using a heavy and rigid carcasses upon which to base the structural integrity of a cabinet system. The new lightweight cabinet system of the innovation employs a combination of lightweight molded materials utilizing a combination of at least two different materials, and in some embodiments three or more materials, to create a lightweight cabinet system that is structurally sound and also functional. In particular, the system may include high-strength shelving that forms a type of internal spine-like system within the cabinet for support. Additionally, the use of multiple materials in the construction of the innovation allows the system to be color matched to suit a customer's requirement, as desired. Additionally, the cabinet system may include a class A surface that can also be textured to meet the end users styling requirements. The surface touch of this material can be adjusted to allow for a “soft touch feel,” which may be of both aesthetic value and a safety enhancement when used in the interior of passenger-bearing vehicles.

In a typical embodiment, intended by way of example only and not limitation, manufacturing the components of the example cabinet 400 utilizes two reaction injection molding processes. In the embodiment of FIG. 4, major carcass components and the cabinet door may be made by a vinyl clad rigid molding process, or “IVCR” process. In a typical reaction injection molding technique of the innovation, a surface vinyl is inlaid in a mold prior to injecting the plastic material. The surface vinyl may be of virtually any color or texture specified by an end-user. In this example, the plastic material is created by combining two chemicals, isocyanate and polyol in an approximate ratio of 50-50. An exothermic (heat-generating) chemical reaction between the isocyanate and the polyol occurs, forming the desired part in a lightweight plastic material that is bonded to the vinyl in this cladding process.

As described above, the top, sides and back (402, 404, 406 respectively) can be manufactured using the IVCR process described above. The bottom shelf 410 can be manufactured by way of the T-RIM™ process described above. It will be appreciated that both the IVCR and T-RIM™ processes are reaction injection molding processes. Additionally, both of these processes enable a top-good (e.g., vinyl) to be adhered to the part within the molding process(es). Still further, metal inserts (and/or magnets) can be embedded within the molded part(s). In the molding process, magnets can be employed within the mold in order to align and retain alignment of the metal inserts within the molded part(s).

It will be appreciated that conventional plastic components typically could display the following physical properties (expressed in SI units); a nominal molded density of 0.34+/−0.02 Sg, a flexural strength greater than 11.0 MPa, a tensile strength of at least 6.9 MPa, and a elongation of approximately 7-10%. In one particular embodiment, the material may have a flexural modulus, measured at 22 degrees Centigrade, greater than or equal to approximately 200 MPa. As one skilled in the art would realize, such lightweight plastic components may not display sufficient rigidity and overall strength to ensure the structural integrity of the cabinet system.

Certain other components of the carcass (e.g., bottom shelf 410) may be made of a low-density reinforced injection molded polyurethane with the addition of a filler material that adds structure and rigidity (e.g., T-RIM™ process molding). As described above, in one aspect, the filler material is wollastonite, a calcium inosilicate mineral (CaSiO3) that may contain small amounts of iron, magnesium, and manganese substituting for calcium. Such polyurethane components typically could display the following physical properties (expressed in SI units); a nominal molded density of 0.56+/−0.05 Sg, a flexural strength greater than or equal to 24.1 MPa, a tensile strength of at least 13.8 MPa, and a elongation of approximately at least 10%. In one particular embodiment, the material may have a flexural modulus, measured at 70 degrees Centigrade, greater than or equal to approximately 500 MPa.

Substantial strength is imparted to the cabinet system of the innovation by both the composition and design of shelving components in the interior of the system, in addition to composition and design of the top, back, sides and bottom surfaces. In aspects, shelving components 412 may include an injection molding material with a 20% glass reinforced, chemically coupled, impact modified polypropylene. Such a formulation utilizes a gas assist molding process to help fill out and pack out the structural design of the product, and provides enhanced stiffness and strength. Such polyurethane components typically could display the following physical properties (expressed in SI units); a specific gravity of approximately 1.04 Sg, a tensile strength at yield of approximately 67 MPa, and elongation at break of approximately 4.0%. In one particular embodiment, the material may have a flexural modulus greater than or equal to approximately 4000 MPa.

Further, such glass reinforced polyurethane may be molded with a variety of structural patterns. For example, in a typical embodiment, the underside of shelving components 412 may be molded with a diamond shaped rib pattern, as would be known by one skilled in the art that greatly improves the structural strength and rigidity of the component. These shelving components 412, affixed to the interior of the carcass, create a strong, internal, spine-like structure that contributes a majority of the structural strength and rigidity of the system 400, once again in contrast with conventional assembly, which relies on a heavy and rigid cabinet carcass for such strength.

Overall, the combination of the aforementioned materials and processes results in a cabinet system 400 that reduces the weight considerably over a conventional steel and/or combination of steel and other materials. While the system has, as one skilled in the art would know, virtually universal utility in most any application in which weight, strength, and appearance are factors, it is particularly useful in motor vehicle applications, and in particular to heavy truck sleeper cabs previously noted. In a typical embodiment, the overall specific gravity, or density, of these cabinet components, in aggregate and not including any (optional) metal fasteners or parts, may be 1.3 or less. This is contrasted with prior art steel cabinetry, which has an overall specific gravity, or density, of approximately 7.7. It will be appreciated that the reduced weight can enhance fuel efficiency of a vehicle.

As described above, the innovation can provide for effectively modular parts. For example, sides and shelving can be interchangeable between a smaller (e.g., “A”) or larger (e.g., “B”) cabinet. It will be appreciated that “A” and “B” illustrate door components of a smaller and larger cabinet respectively. Thus, in operation, a series of smaller, larger or combination thereof can be installed to achieve a desired overall cabinet assembly length.

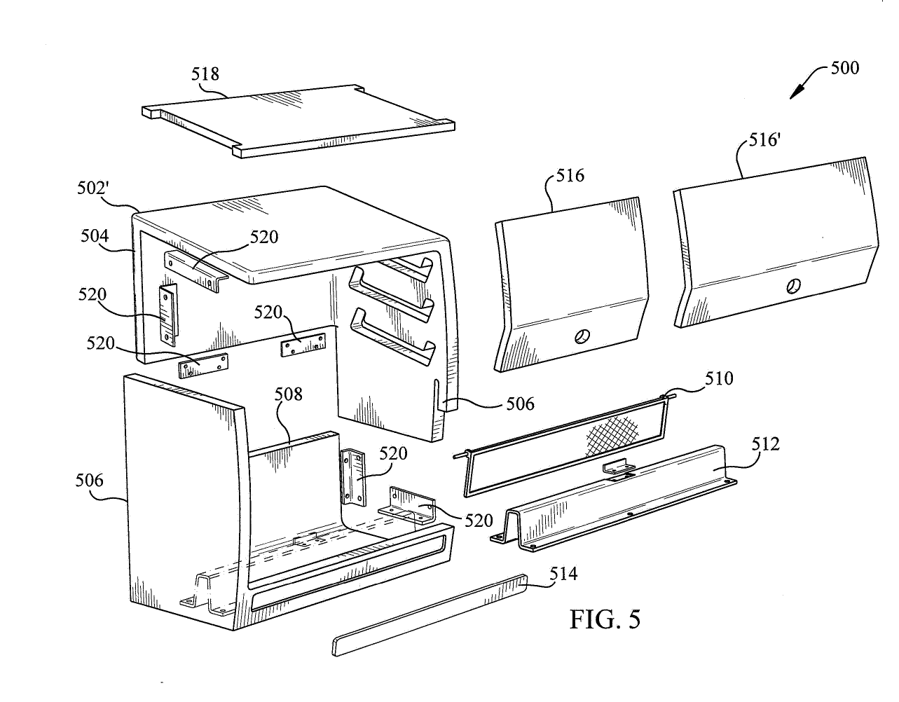

FIG. 5 illustrates an alternative example of a cabinet 500 in accordance with aspects of the innovation. In general, FIG. 5 illustrates a cabinet 500 in an assembly phased manufacturing process workflow view.

Consistent with the aforementioned examples, a multi-material cabinet system (500) having a high structural strength to weight ratio including a polymeric carcass having a plurality of cabinet components is shown. These components may include, as shown in FIG. 5, some or all of the following: a top (502), a back (504), a pair of sides (506), one or more shelves (not shown), a bottom (508), various trim (510, 512, 514) pieces, and, in some embodiments, a door (516 and 516′). It will be a understood that two example door sizes are shown to illustrate the modular characteristics of the innovation. This list of components is not intended to be exclusive. Accordingly, as shown and different from some of the aforementioned examples, the system may be formed or configured using a continuous side/bottom component (e.g., 506) or the absence of any door (516, 516′). In this example, the top panel 502 can be integrally or continuously molded with side panel 506, thereby streamlining the manufacturing process. Similarly, the bottom panel 508 can be integrally molded to the other of the side panels 506 as shown. In aspects, top panel cover 518 can be installed so as to effect or assist in operation of an optional cover or door assembly (516, 516′).

The assembly of at least some of these components defines an interior cabinet volume. In certain embodiments, the overall specific gravity of the cabinet components in aggregate may be less than 1.3, as compared to a much higher specific gravity of conventional cabinets. Further, it is to be understood that, some of the components, by design, maybe manufactured of metal. For example, trim components 510, 512, 514 as well as bracket assemblies 520 may be manufactured from metal or other suitably rigid material.

In view of the aforementioned material processes (i.e., IVCR, T-RIM™, injection molding), the cabinet system (500) may further include at least a first cabinet component having a first cabinet component material flexural modulus of less than 500 MPa and at least a second cabinet component having a second carcass component material flexural modulus of at least approximately 4000 MPa. In one embodiment, the second cabinet component is at least partially enclosed within the interior cabinet volume of the cabinet 500. In particular embodiments, as seen in FIG. 1, the first cabinet component is selected from the group including the top, back, sides, bottom trim, and door; while the second cabinet component is at least one interior shelving component.

Returning to FIG. 5, in an alternate embodiment, the multi-material cabinet system (500) has a polymeric cabinet including a plurality of cabinet components that define an interior cabinet volume, where a first cabinet component material flexural modulus is at least ten times less than a second carcass component material flexural modulus. Again, in the particular embodiment, the first cabinet component is selected from the group including the top, back, sides, bottom trim, and door; while the second cabinet component is at least one interior shelving component (not shown in FIG. 5). The multi-material cabinet system (500) may further include an operable door (e.g., 516, 516′).

It will be appreciated that, although the aforementioned examples describe two disparate materials, in yet another embodiment, the cabinet system (500) may further include at least a third cabinet component having a third carcass component material flexural modulus intermediate between the first carcass component material flexural modulus and the second carcass component material flexural modulus. In still another particular embodiment, the first cabinet component is selected from the group including the top, back, sides, trim, and door; while the second cabinet component is at least one interior shelving component (not shown), and the third cabinet component is the bottom (508). One skilled in the art will realize that this is not the only possible arrangement of components.

It is to be appreciated that most any means can be employed to connect (e.g., fixedly adhere or removably attach) components of the cabinet system 500. In the example of FIG. 5, a plurality of “L” brackets or flanges 520 can be employed to connect the components. It will be appreciated that these brackets 520 can mate and be fixedly attached using hardware such as nuts, bolts, screws or the like. In other aspects, the components can be snapped or otherwise connected (e.g., grooves, guides). Still further, as desired, adhesives or the like can be employed to connect components of the cabinet system.

In addition to the aforementioned improvement in the structural strength to weight ratio achieved by the system 500, the materials employed in connection with the innovation can have enhanced thermal and acoustic advantages over steel and hard plastic materials used in conventional or traditional cabinet systems. In particular, surfaces can be made soft and sound absorbing, and yet be water-resistant and easily cleaned.

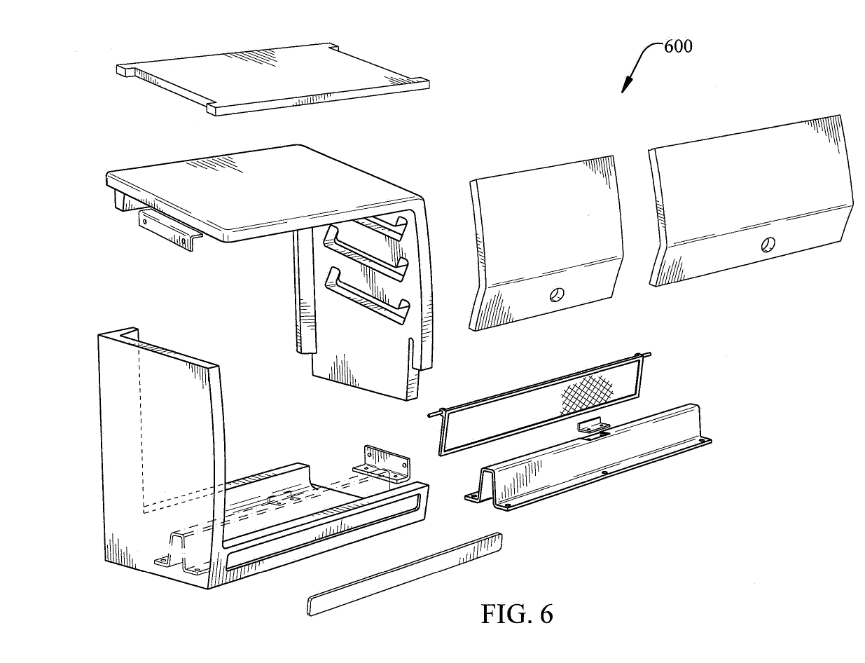

FIG. 6 illustrates yet another example of a multi-composite cabinet system 600 in accordance with the innovation. As illustrated, the cabinet system 600 of FIG. 6 need not include a back component. Similarly, if desired, more or fewer interior shelves can be employed in aspects. Still further, although shown, a door or cover need not be provided as desired or appropriate.

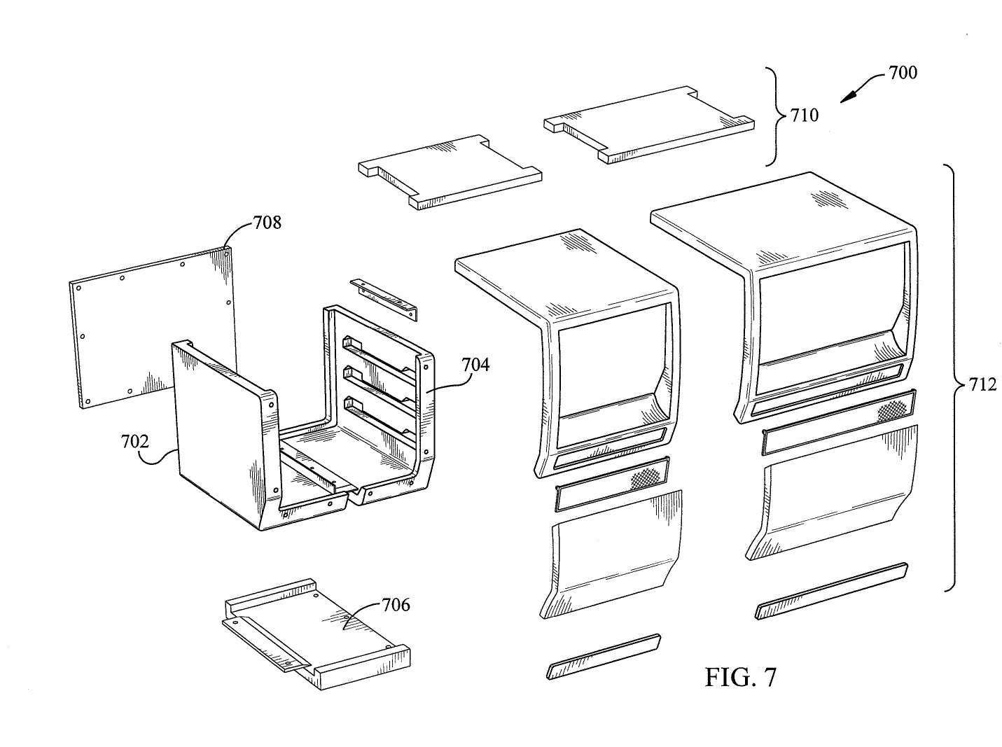

FIG. 7 illustrates yet another aspect of the innovation. As shown, cabinet assembly 700 can include an integrally molded side panel 702, 704 wherein the side panel is molded together with a lower or bottom section. A floor section 706 can be applied beneath (or above) the bottom sections of 702, 704. It will be appreciated that this floor section 706 can provide additional strength so as to enhance the strength to weigh ratio. Other components shown in FIG. 7 include, but are not limited to, a back portion 708, top portion 710, and door assemblies (712); of various sizes as illustrated.

As described supra, it is to be understood that the molding processes employed herein enable most any configuration of multi-composite cabinet assembly to be manufactured. For instance, cabinets with integral top, back and side panels can be produced. Cabinets with integral side and bottom panels (e.g., 700) can be produced. Still further, cabinets with integral side and top panels can be produced. As well, cabinets can be produced with individual components all together. It will be appreciated that these examples provide perspective to the innovation and that other combinations may be configured without departing from the features, functions and benefits described herein. It will be appreciated that, in accordance with the molding processes described herein, the top good (e.g., vinyl) can be on one side of a molded part while the opposite side reflects the uncovered RIM surface.

It is to be appreciated that some aspects may employ metal (e.g., steel, aluminum, alloy) flanges, brackets, face plates, internal shelves, etc. by design. For example, extruded metal mounting brackets or flanges can be employed to connect cabinet components (e.g., sides to back) as well as to connect the cabinet to a surface as desired (e.g., to a wall surface). However, even though minimal metal parts may be employed, enhanced strength to weight ratio can still be realized due to the multi-composite design of the overall cabinet. In lieu of metal brackets, flanges, face plates, etc., it will be understood that some aspects employ other materials including, but not limited to carbon fiber or the like.

In an example process of manufacturing, the components of a cabinet assembly can be configured using disparate molding processes by design or as desired. In accordance therewith, a top good can be applied on exposed (or integral) surfaces as desired. Moreover, as described, the molding processes can enable the cabinet to have an enhanced strength to weight ratio as compared to conventional cabinet designs. In addition to the high strength, the lower weight, especially in long haul trucks, can enhance fuel efficiency, monetary savings and overall environmental benefits.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-composite cabinet system having high structural strength to weight ratio, comprising:
a polymeric carcass having a plurality of cabinet components that define an interior cabinet volume; the polymeric carcass comprises:
a first component with a material flexural modulus of less than 500 MPa; and
a second cabinet component with a flexural modulus of at least approximately 4000 MPa; wherein the first component together with the second component have an overall specific gravity in aggregate less than 1.3.

2. The multi-composite cabinet system of claim 1, further comprising a third cabinet component enclosed within the interior cabinet volume.

3. The multi-composite cabinet system of claim 1, wherein one of the first component or the second component is a contiguously molded top, back and bottom surface and the other of the first component or the second component is a bottom shelf surface.

4. The multi-composite cabinet system of claim 1, wherein one of the first component or the second component is a contiguously molded top and side surface and the other of the first component or the second component is a bottom shelf surface.

5. The multi-composite cabinet system of claim 1, wherein one of the first component or the second component is a contiguously molded side and bottom surface and the other of the first component or the second component is a top surface.

6. The multi-composite cabinet system of claim 1, wherein one of the first component or the second component is molded via an IVCR (Improved Vinyl Clad Rigid) process and the other of the first component or the second component is molded via a T-RIM™ process, wherein the T-RIM™ process employs injection of a filler to enhance strength of a molded component.

7. The multi-composite cabinet system of claim 6, wherein the filler material is wollastonite.

8. The multi-composite cabinet system of claim 6, further comprising a door assembly that encapsulates the interior cabinet volume.

9. The multi-composite cabinet system of claim 6, further comprising a plurality of injection molded shelves positioned within the interior cabinet volume.

10. The multi-composite cabinet system of claim 1, wherein at least one of the first component or the second component includes integrally molded metal inserts that mate to closure magnets.

11. A method for manufacturing a multi-composite cabinet having a high strength to weight ratio, comprising:
employing a first reaction injection molding process to form a first component;
employing a second reaction injection molding process to form a second component; and
fixedly attaching the first component to the second component to establish a case with a specific gravity of 1.2 or lower.

12. The method of claim 11, wherein the first reaction injection molding process is an IVCR (Improved Vinyl Clad Rigid) process.

13. The method of claim 12, wherein the second reaction injection molding process is a T-RIM™ process that employs a filler material to enhance strength of a molding.

14. The method of claim 11, wherein each of the first and second molding processes comprise an act of inserting a top good into a mold prior to injection of a composite material.

15. The method of claim 14, wherein the top good is vinyl.

16. The method of claim 11, wherein at least one of the first and second molding processes comprise an act of inserting a metal positioning into a mold prior to injection of a composite material, wherein the metal insert mates to a magnet closure in an assembled cabinet.

17. A composite cabinet system, comprising;
means for applying a top good to one half of a mold in a reaction injection molding system, wherein the molding system includes a two-part mold;
means for injecting a composite material into a closed two-part mold;
means for positioning a metal insert for encapsulation within the composite material; and
means for de-molding a multi-material cabinet component that includes the top good adhered to a composite part that encapsulates the metal insert.

18. The composite cabinet system of claim 17, wherein the means for positioning the metal insert comprises one or more magnets affixed to one side of the two-part mold.

19. The composite cabinet system of claim 17, further comprising means for injecting a filler into the composite material, wherein the filler enhances strength of the composite part.

20. The composite cabinet system of claim 17, wherein the filler is wollastonite.
